(19) United States
(12) Patent Application Publication
(10) Pub. No.: US 2008/0061542 A1
(43) Pub. Date: Mar. 13, 2008

(54) Motor Vehicle with a Roll Bar Configuration

(75) Inventors: Mathias Froschle, Ostfildern (DE); Markus Schulzki, Ludwigsburg (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/852,537

(22) Filed: Sep. 10, 2007

(30) Foreign Application Priority Data
Sep. 8, 2006 (DE) DE102006042284.8

(51) Int. Cl. B60R 21/13

(52) U.S. Cl. 280/756

(57) ABSTRACT

A motor vehicle contains a roll bar configuration which has at least one U-shaped roll bar, a transverse strut, and a connecting element with a receiving opening which accommodates one end of the roll bar. The connecting element can be connected releasably or nonreleasably both to the outer and to the inner body wall which is/are disposed generally vertically and/or horizontally. Furthermore, it is provided, on the connecting element, to arrange bearing points to which a foldable top and/or a belt deflecting lever can be fastened.

### CROSS-REFERENCE TO RELATED APPLICATION

This application claims the priority, under 35 U.S.C. §119, of German application DE 10 2006 042 284.8, filed Sep. 8, 2006; the prior application is herewith incorporated by reference in its entirety.

### BACKGROUND OF THE INVENTION

1. Field of the Invention

The present invention relates to a motor vehicle with a roll bar configuration which contains at least one roll bar, a transverse strut, and a connecting element with a receiving opening in which one end of the roll bar is accommodated. Furthermore, the invention relates to a connecting element for a roll bar configuration in the motor vehicle.

Known roll bar configurations in motor vehicles usually contain a substantially horizontal transverse strut disposed parallel to the transverse axis of the vehicle and two generally U-shaped roll bars. The roll bars are fastened at the end which faces the center of the vehicle to the transverse strut and, at their second end which extends toward the outside of the vehicle, are connected to the vehicle body via connecting devices. The transverse strut is preferably likewise fastened to the vehicle body by this connecting device.

Various embodiments are known for roll bar configurations of this type. For example, German patent DE 102 18 701 C1 describes fastening feet made from light metal casting, at which the transverse strut is plugged onto engagement sections formed integrally on the fastening feet, and is fastened thereto. In this case, that end of a roll bar which faces the outside of the vehicle is screwed separately to that side of the fastening foot which lies opposite the transverse strut. In this embodiment, a top mounting, in which a foldable vehicle top is movably coupled, is integrated in the cast fastening foot.

Published, European patent application EP 1 547 874 A1, corresponding to U.S. patent publication No. 2005/0140129 A1, describes a roll bar configuration in which the ends of the roll bars, which face the outside of the vehicle, clearly extend downward over the plane of the transverse strut. These extended ends of the roll bar pass through the transverse strut and are screwed to the latter. Tabs are fitted to this screw connection and connect the fastening junction of the transverse strut and roll bar to a fastening element which, in turn, is fastened to the lateral inner wall of the body. In addition, the downwardly extended ends of the roll bars are screwed to a horizontally extending body wall and, in the region between the transverse strut and the horizontal body wall, are likewise connected via a tab to the outer wall of the body. In the case of this roll bar configuration, the fastening element, which is composed of a worked part, has, on the outer wall of the body, an extension to which bolts and other fastening elements for the mounting of the top are fitted.

In these known systems, the force flux between the elements of the roll bar configuration is frequently not guided in such a manner that an optimum load-bearing capacity of the connection of the roll bar configuration to the vehicle body, which connection is important for vehicle safety, is achieved. This furthermore adversely affects the strength of the vehicle body.

Furthermore, it is known, for example, from published, non-prosecuted German patent application DE 199 31 224 A1 to insert deformation elements into roll bar configurations in order to improve the force absorption capacity thereof, as a result of which an additional outlay on installation is created.

### BRIEF SUMMARY OF THE INVENTION

It is accordingly an object of the invention to provide a motor vehicle with a roll bar configuration which overcomes the above-mentioned disadvantages of the prior art devices of this general type, which has an improved roll bar configuration which, in particular, increases the strength of the vehicle body.

With the foregoing and other objects in view there is provided, in accordance with the invention, a motor vehicle. The motor vehicle includes a roll bar configuration including: at least one roll bar, a transverse strut, and a connecting element with a receiving opening formed therein accommodating one end of the roll bar and also one end of the transverse strut.

In the case of a motor vehicle with a roll bar configuration according to one embodiment of the present invention, the connecting elements each contain a receiving opening in which both one end of a roll bar and one end of the transverse strut are accommodated. The transverse strut can be produced, for example, from a customary tubular semi-finished product, or as a worked part or preferably as an extruded profile. An advantage of a common mounting of the ends of transverse strut and roll bar is the joining of both elements into a common force flux, the effect of which is that forces which act on one of the two elements from the outside can also be absorbed by the respectively other element, thus obtaining a significantly increased vehicle rigidity.

In this case, the receiving opening in the connecting element is preferably configured to be open upward and in the direction of the center of the vehicle. The receiving opening is therefore opened in each case in the direction of the elements to be received, the ends of the roll bar and of the transverse strut. The receiving opening is closed in the direction of the side of the vehicle and of the floor of the vehicle. Forces which are introduced are therefore virtually absorbed within the connecting element. In the driving mode and in the event of an impact, critical forces pointing away from the floor of the vehicle in the vertical direction and requiring a form-fitting connection in this direction do not occur. Owing to the mirror-inverted configuration of the roll bar configuration according to the invention, the forces which act horizontally along the transverse axis of the vehicle in the direction toward the center of the vehicle are introduced into the vehicle body on the opposite side of the vehicle.

The one end of the roll bar and that of the transverse strut are preferably configured in such a manner that they are absorbed generally in a form-fitting manner and advantageously as one unit by the receiving opening of the connecting element. Such a configuration simplifies the installation of the roll bar configuration in the motor vehicle and permits forces which occur to be introduced in a frictional manner via contact surfaces into the connecting element. The transmission of forces between the ends of the roll bar and of the transverse strut also takes place by them being supported on component edges or surfaces.

In order to secure the elements in the receiving opening, it is also possible to provide releasable fastenings. This facilitates the installation and, in particular, permits a simpler retrospective exchange of damaged components. Equally, nonreleasable fastenings can also be provided. The latter advantageously reduce the number of installation steps and the components required in this case, and reduce the weight of the configuration and increase the strength of the connection. By the configuration (from one side of the vehicle to the other side of the vehicle) of the connecting element—the roll bar end—the transverse strut—the roll bar end—the connecting element, a very stiff configuration is thus produced in the transverse direction of the vehicle, which configuration, fitted as a structural component in the body shell, significantly increases the rigidity of the body shell. In this case, the ends of the roll bars, which are preferably tubular, serve as deformation elements which absorb transverse forces occurring, for example, in the event of a side impact. Owing to the ends of the roll bars additionally being enclosed by the receiving opening, which additionally has a stiffening effect, a further consumption of energy is possible. The closed configuration of the receiving opening in the direction of the longitudinal axis of the vehicle makes it possible for even relatively high forces which are introduced obliquely to or in the direction of the longitudinal axis of the vehicle to be absorbed by the connecting element.

Forces which are introduced via a roll bar are also absorbed better by this compact roll bar configuration, which reaches from body wall to body wall, than by known roll bar configurations. Vertical forces on the roll bar are transmitted directly from the roll bar cross section, which is preferably extensively accommodated in the receiving opening, to the connecting element and therefore into the vehicle body. Forces applied obliquely to the roll bar are absorbed both by the transverse strut and by the connecting element as a function of the direction of force and are introduced into the vehicle body.

Owing to the simplified construction and the associated lack of need for force-transmitting fastening elements, the installation, which for the most part preferably takes place by a plug-in connection of the individual elements of the roll bar configuration, can be carried out in a highly simplified manner.

To achieve the object described, it is advantageous if, in a further preferred embodiment, the connecting element is supported on an outer and an inner body wall of the vehicle. In this case, the inner body wall can be disposed substantially vertically and/or substantially horizontally in accordance with the body construction present. In particular, it may be the roof of an engine compartment.

The effect achieved by connecting the connecting element both to the outer and to the inner body wall is a particularly stiff and fixed connection in which forces, in particular vertical forces, introduced into the connecting element can advantageously be introduced into the vehicle body. First, the connecting surface which is enlarged by the double connection can contribute to this. Equally, the connections to the outer and inner body walls can be oriented differently and can thus optimally absorb differently directed forces. If, for example, the inner body wall is substantially horizontal, the connecting element can be supported on it in the vertical direction, and therefore the connection to the outer body wall, which is generally vertical, only absorbs small shearing forces. A tensile force in the horizontal longitudinal direction of the vehicle, as occurs, for example, when opening a top coupled to the connecting element, is advantageously absorbed via the connection to a substantially horizontal, inner body wall and reduces shearing forces occurring in the outer body wall.

According to the invention, the connection of the connecting element to the two body walls can be configured in each case to be both releasable and non-releasable. Fastening elements, such as screws, rivets, bolts or snap connections, are preferably used for releasable connections, and connecting techniques, such as welding, soldering, adhesive bonding or nonreleasable working processes are preferably used for nonreleasable connections.

Most of the forces introduced into the vehicle body by the connecting element via the body walls are particularly preferably transmitted in a form-fitting manner. It is particularly advantageous if the connecting element can be supported on a horizontal body wall, for example in the event of a vehicle overturning. Even on substantially vertical body walls, the connecting element can be supported on projections which are preferably integrated in the walls and improve the introduction of force.

It is likewise particularly advantageous to integrate the bearing of the top into the connecting element. By the improved transmission of force described from the connecting element into the body walls and also into the roll bar configuration, the transverse forces introduced into the bearing of the top and, in particular, the very high tensile forces which act in the bearing during the opening and closing operations can be absorbed and passed on into the vehicle body.

Owing to the above-mentioned reasons, it is preferably also expedient likewise to dispose a belt deflecting lever, which is disposed in this region of the vehicle body, on the connecting element. The optimized introduction of force from the belt deflecting lever into the vehicle body via the connecting element, which introduction of force is provided by the roll bar configuration disposed in the motor vehicle according to the invention, is extremely advantageous precisely for occupant protection.

In order to satisfy the diverse requirements imposed on the connecting element by the above described objects and configurations, the connecting element is preferably configured as welding, forged or worked structures. However, it is particularly advantageous to produce the connecting element as a cast part, since cast parts have very high mechanical strength and afford the design advantages required for connecting elements of this type.

In a particularly preferred embodiment, the connecting elements integrated into the roll bar configuration are supported both on an inner and on an outer body wall. This complements the above-mentioned advantages according to the invention, thus creating a significantly improved motor vehicle with roll bar configuration in comparison to the previously known prior art.

Particularly advantageous features of this embodiment of the motor vehicle according to the invention with roll bar configuration are improved absorption of forces, passing them on into the vehicle body and, if required, even consumption of forces which are first introduced into the vehicle body via the roll bar or second, such as, for example, in the case of a side impact, via the opposite side of the vehicle. The roll bar configuration according to the invention, which can be integrated in the vehicle directly behind the backrests of the vehicle occupants, therefore provides a significantly increased transverse stiffening of open vehicles.

The integrated mounting of the top in the motor vehicle according to the invention introduces the forces transmitted to the vehicle via the top and forces from the belt deflecting lever into the vehicle body in an optimized manner and therefore increases the safety of the vehicle occupants.

Apart from the locking to the windshield, a vehicle top is only connected fixedly to the vehicle at the mounting of the top. It is therefore particularly advantageous for transverse forces which act on the top and can be relatively high even at low side wind speeds to be absorbed by the bearing points of the top in the region of the roll bar configuration. By the integration of the mounting of the top into the force flux of the roll bar configuration, potentials which are consequently present for stabilizing the bearing of the top are exhausted.

However, when opening and closing the top during the journey, the highest forces are introduced into the bearing of the top. In this case, the large area subjected to the relative wind results in high tensile forces act on the mounting of the top. Furthermore, the integration of the mounting of the top into the roll bar configuration of the motor vehicle according to the invention permits simplified installation of the mounting of the top and of the top on the bearing of the top.

This particularly preferred embodiment is also distinguished overall by a significant improvement in the ease of installation of all of the components of the roll bar configuration. This applies both with respect to the accommodating of the ends of roll bar and transverse strut in the connecting element and with regard to the force-transmitting fastening of the connecting element to the vehicle body, which fastening preferably takes place at least partially in a form-fitting manner especially in the region of inner body walls. The resultant omission of additionally required fastening elements proves advantageous for the weight of the vehicle and likewise for the assembly costs of the vehicle. In this case, not only are the costs for the fastening elements dispensed with but so too are the costs for fitting them into the vehicle. According to a particularly preferred embodiment, the force flux within the roll bar configuration and the transmission of introduced forces into the vehicle body have proven particularly advantageous. The reduced space required by the roll bar configuration in the vehicle on account of the simple and effective configuration is to be stated as a further advantage of the particularly preferred embodiment.

The optimized force flux between the elements of the roll bar configuration is to be emphasized as a particular advantage of the motor vehicle according to the invention. By this measure, the load-bearing capacity of the connection of the roll bar and the transverse strut, which connection is important for the safety of the vehicle, in particular the rollover resistance, and also for the rigidity of the vehicle, in particular the transverse rigidity, is considerably improved. Furthermore, the roll bar configuration of the motor vehicle according to the invention avoids any interruption of the force flux or strength-reducing force profiles which, in the case of known systems, due to a separate mounting of the transverse strut and of the roll bar, reduce the capability of absorbing introduced forces.

A further advantage of the vehicle according to the invention is the integration of the roll bar configuration, which is disposed directly behind the backrests of the vehicle occupants, into the safety concept of open vehicles in the form of an additional transverse stiffening measure. The vehicles, because they lack a B-pillar, have a reduced transverse rigidity in the region behind the vehicle doors, the transverse rigidity being significantly improved by the use of the roll bar configuration.

Other features which are considered as characteristic for the invention are set forth in the appended claims.

Although the invention is illustrated and described herein as embodied in a motor vehicle with a roll bar configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, three-dimensional view of a roll bar configuration in a motor vehicle according to the invention;

FIG. 2 is a diagrammatic, three-dimensional view of a connecting element as seen in a direction of a rear of the vehicle;

FIG. 3 is a diagrammatic, sectional view of the connecting element taken along the section line III-III shown in FIG. 2 through a receiving opening with ends of the roll bar and of the transverse strut disposed therein; and

FIG. 4 is a diagrammatic, three-dimensional view of the connecting element as seen in the direction of the front of the vehicle.

### DESCRIPTION OF A PREFERRED EMBODIMENT OF THE INVENTION

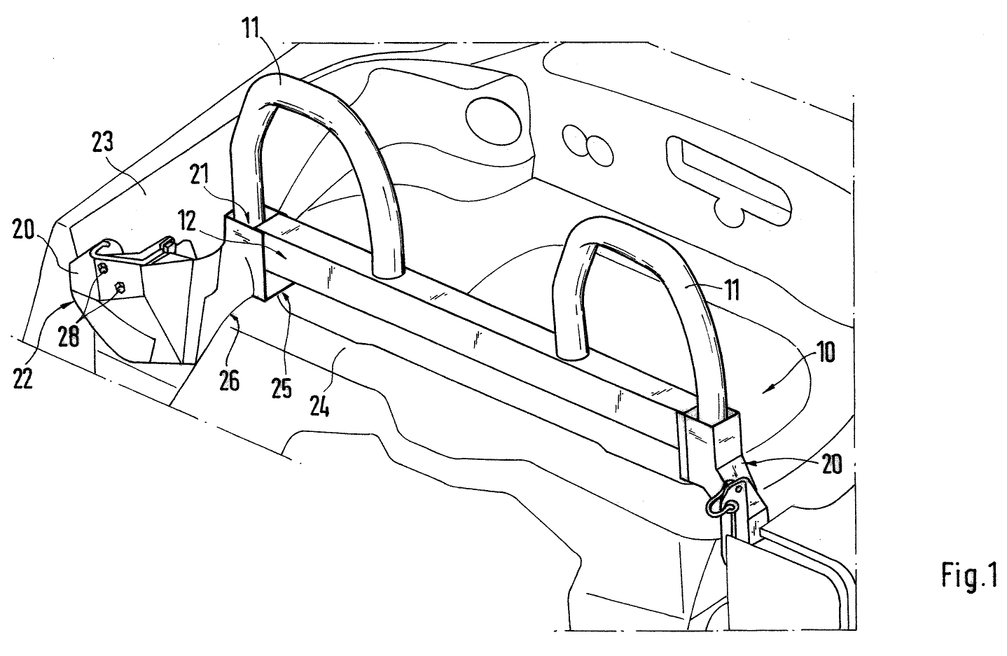

Referring now to the figures of the drawing in detail and first, particularly, to FIG. 1 thereof, there is shown a three-dimensional view of a roll bar configuration 10 according to the invention which is illustrated fitted into a motor vehicle. In this case, the roll bar configuration 10 contains two U-shaped roll bars 11, a transverse strut 12 and a connecting element 20 with a receiving opening 21. One end of a roll bar 11 and one end of the transverse strut 12 are accommodated in each case in the receiving opening 21. The connecting elements 20, which are disposed on both sides between the transverse strut and the inner wall of the body, are of mirror-inverted design. The connecting element 20 is fastened to the outer body wall 23 at a contact surface 22. In the exemplary embodiment, the connecting element 20 is first fastened in a form-fitting manner, but additionally by a screw connection 28 to the outer body wall.

The connecting element 20 is supported horizontally via a contact surface 25 and additionally vertically via a contact surface 26 on the inner body wall which is formed, in the exemplary embodiment, by the roof of the engine compartment. In the embodiment shown, no further fastening elements are fitted on the contact surfaces 25 and 26.

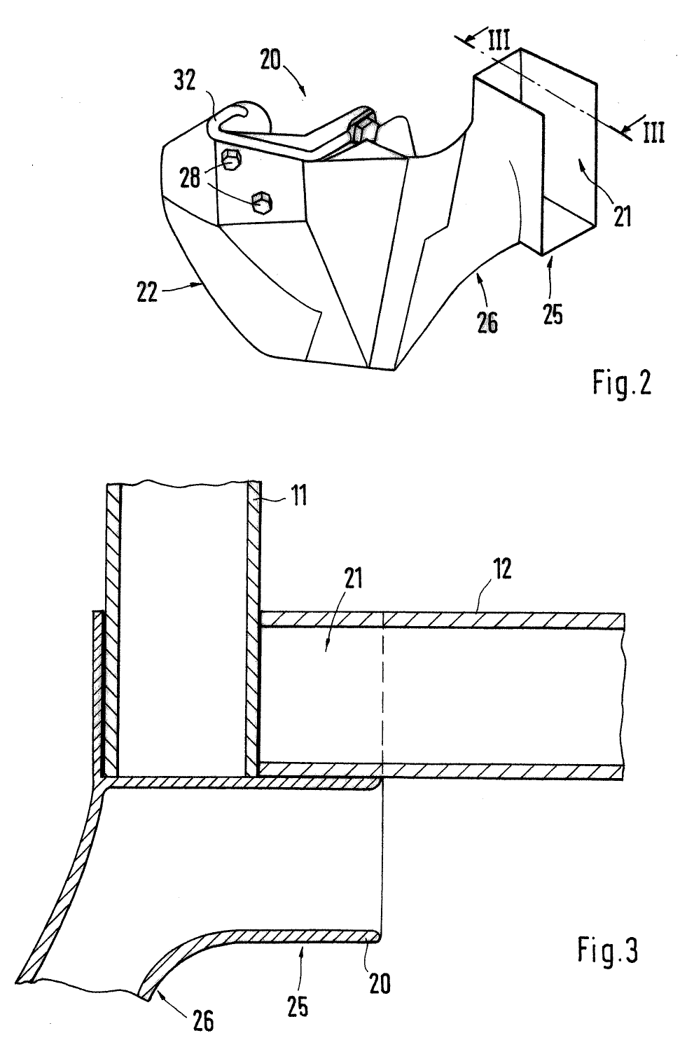

The ends of the roll bar 11, which ends face the longitudinal center axis of the vehicle, are fastened in a suitable manner in or to the transverse strut 12. The ends of the roll bars, which point in the direction of the outer body walls, are accommodated in the receiving opening 21 of the connecting element 20, which is illustrated in FIG. 2.

FIG. 3 shows a section through the connecting element 20 along the section line III-III shown in FIG. 2 through the receiving opening 21 and the ends, located therein, of the roll bar 11 and of the transverse strut 12. In this exemplary configuration, the transverse strut 12 can be supported via the end of the roll bar 11 in the connecting element 20 and therefore on the outer body walls 23 in the event of loading in the longitudinal direction (transversely with respect to the longitudinal axis of the vehicle). In this case, use is also made of the transverse stability of the tubular end of the roll bar 11, which is additionally held by the receiving opening. In the event of a loading in which forces occur in the longitudinal direction of the vehicle or on the vehicle in the vertical direction, the forces are transmitted directly or partially via the end of the roll bar 11 into the connecting element and therefore to the vehicle body. Very high forces introduced lead to the deformation of the cross section of the roll bar 11, with the receiving opening 21 of the connecting element 20 likewise undergoing deformation.

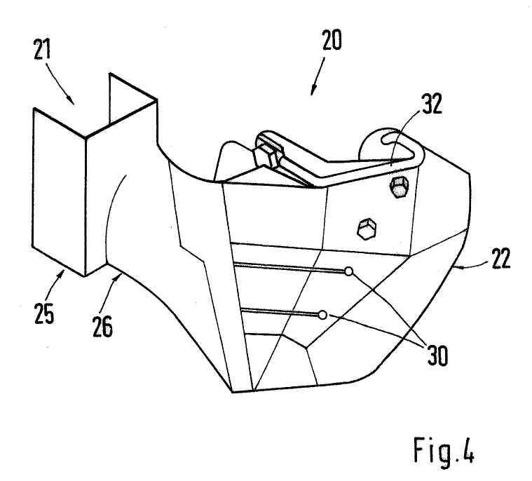

FIG. 4 shows the connecting element 20 from the rear of the vehicle as seen in the direction of the front of the vehicle. A bearing 30 of the top, which is integrated in the connecting element 20 and to which the top is rotatably coupled, can be seen in this view. Transverse forces introduced into the top and, in particular, the tensile forces occurring during the opening and closing of the moving vehicle are absorbed by the bearing 30 of the top and are introduced into the vehicle body via the connecting element 20 and via the contact surfaces 22, 25 and 26 thereof. A belt deflecting lever 32 which likewise introduces high forces into the vehicle body in the event of an impact is also shown here.

1. A motor vehicle, comprising:
a roll bar configuration including:
at least one roll bar;
a transverse strut; and
a connecting element with a receiving opening formed therein accommodating one end of said roll bar and also one end of said transverse strut.

2. The motor vehicle according to claim 1, wherein said receiving opening is open upward and in a direction of a transverse axis of the motor vehicle.

3. The motor vehicle according to claim 1, wherein said roll bar is U-shaped.

4. The motor vehicle according to claim 1, further comprising:
an inner body wall; and
an outer body wall, said connecting element on which said transverse strut and said one end of said roll bar are disposed, is supported on said outer body wall and said inner body wall.

5. The motor vehicle according to claim 4, wherein said inner body wall on which said connecting element is supported is at least one of generally vertical and generally horizontal.

6. The motor vehicle according to claim 4, wherein said connecting element is connected releasably to at least one of said inner body wall and said outer body wall.

7. The motor vehicle according to claim 4, wherein said connecting element is connected nonreleasably to at least one of said inner body wall and said outer body wall.

8. The motor vehicle according to claim 1, further comprising a foldable top coupled to said connecting element.

9. The motor vehicle according to claim 1, wherein said connecting element has at least one bearing point and a belt deflecting lever disposed on said bearing point.

10. The motor vehicle according to claim 1, wherein said connecting element is an assembled component.

11. The motor vehicle according to claim 10, wherein said assembled component is selected from the group consisting of welded structures, worked parts, forged parts, formed parts, and cast parts.
